(19) United States
(12) Patent Application Publication
(10) Pub. No.: US 2022/0325832 A1
(43) Pub. Date: Oct. 13, 2022

(54) CONNECTOR ASSEMBLY AND METHOD FOR PRODUCING A CONNECTOR ASSEMBLY

(71) Applicant: Henn GmbH & Co KG., Dornbirn (AT)

(72) Inventor: Manuel KOENIG, Lustenau (AT)

(73) Assignee: Henn GmbH & Co KG., Dornbirn (AT)

(21) Appl. No.: 17/634,042

(22) PCT Filed: Sep. 16, 2020
(86) PCT No.: PCT/AT2020/060335

§ 371 Date: Feb. 9, 2022

(30) Foreign Application Priority Data
Sep. 24, 2019 (AT) A50817/2019

(51) Int. Cl. F16L 27/107

(52) U.S. Cl. CPC F16L 27/107

(57) ABSTRACT

The invention relates to a plug assembly (1) comprising a tube (3) and a plug connector (4), which comprises a connector body (5), wherein the connector body (5) has an annulus (18) located between a first casing section (9) and a second casing section (12) of the plug connector (4), wherein the tube (3) is inserted into the annulus (18) of the connector body (5), characterized in that
a tube compensating element is arranged between the tube (3) and the second casing section (12), wherein the first casing section (9) of the connector body (5) is deformed such that an interlocking connection is established between a forming region (25) of the first casing section (9) of the connector body (5) and the tube (3), wherein the tube compensating element is clamped between the tube (3) and the second casing section (12).

The invention relates to a plug assembly and to a method for producing the plug assembly.

A plug assembly and a method for producing the plug assembly are known from EP3134670B1.

The plug assembly known from EP3134670B1 has the disadvantage that the production of different plug connectors for different tubes is difficult since a separate forming tool is required for each different design of a plug connector.

It was the object of the present invention to overcome the shortcomings of the prior art and to provide a plug assembly which has a simplified structure as well as to provide a method for producing the plug assembly.

This object is achieved by means of a device and a method according to the claims.

According to the invention, a plug assembly, in particular for use in a vehicle, is provided. The plug assembly comprises a tube and a plug connector, which comprises a connector body, wherein the connector body comprises an annulus located between a sleeve-shaped first casing section annularly surrounding a central longitudinal axis of the plug connector in cross section and a sleeve-shaped second casing section of the plug connector annularly surrounding the central longitudinal axis, wherein the first casing section is surrounded by the second casing section and the first casing section of the connector body is connected to the second casing section on a first end section by a first front wall section and the casing sections are open to one another on a second end section, thereby forming a tube receiving side of the connector body, wherein a connection section of the tube is introduced into the annulus of the connector body from the tube receiving side.

A tube compensating element is arranged between the tube and the second casing section, wherein the first casing section of the connector body is deformed such that an interlocking connection is established between a forming region of the first casing section of the connector body and the tube, wherein the tube compensating element is clamped between the tube and the second casing section.

In an alternative embodiment, a tube compensating element is arranged between the tube and the first casing section, wherein the second casing section of the connector body is deformed such that an interlocking connection is established between a forming region of the second casing section of the connector body and the tube, wherein the tube compensating element is clamped between the tube and the first casing section.

The plug assembly according to the invention has the advantage that by the tube compensating element, tubes with different tube dimensions, in particular different outer diameters or different inner diameters and/or different wall thicknesses may be received in just one dimension size of the plug connector. Thus, it is not required to design a separate plug connector for each tube dimensioning. This entails the advantage that, on the one hand, the susceptibility to errors of the plug connectors can be surprisingly minimized and, on the other hand, costs can be saved. The susceptibility of the plug connectors to errors can be minimized by producing larger quantities in the individual series and thus putting more research work into the forming tool for the plug connector, which can then be of higher quality.

Furthermore, it may be useful if the first casing section of the connector body abuts directly on the tube in the forming region, that the tube abuts directly on the tube compensating element and that the tube compensating element abuts directly on the second casing section. This entails the surprising advantage that a conventional pressing tool can be used to establish the connection between the plug connector and the tube, and different tubes with the same inner diameter and a different outer diameter, and thus a different wall thickness, can be connected to the plug connector. In this regard, the varying gap between the different outer diameters and the second casing section may be compensated by means of different tube compensating elements.

In an alternative embodiment variant, it may be provided that the first casing section of the connector body abuts directly on the tube compensating element, that the tube compensating element abuts directly on the tube and that the tube abuts directly on the forming region of the second casing section. This entails the surprising advantage that a conventional pressing tool can be used to establish the connection between the plug connector and the tube, and different tubes with the same outer diameter and a different inner diameter, and thus a different wall thickness, can be connected to the plug connector. In this regard, the varying gap between the different inner diameters and the first casing section may be compensated by means of different tube compensating elements.

Moreover, it may be provided that the tube compensating element has a longitudinal extension and that the annulus has a longitudinal extension, wherein the longitudinal extension of the tube compensating element amounts to between 80% and 120%, in particular between 90% and 110%, preferably between 95% and 105% of the longitudinal extension of the annulus. By this measure, it may be achieved that in the case of forming regions positioned differently as viewed in the axial direction, it can be ensured in each case that the tube compensation element is also arranged in the forming region as viewed in the axial direction.

An embodiment according to which it can be provided that the tube compensating element has a stepped shoulder on which an end face of the tube abuts. This entails the surprising advantage that the tube compensating element is correctly positioned already while the tube is inserted into the annulus of the plug connector and, moreover, that the tube compensating element can be prevented from falling out as far as possible while it is still unpressed.

In an alternative embodiment variant, it may be provided that a latching connection, by means of which the tube compensating element is coupled with the tube, is formed between the tube compensating element and the tube. Thereby, it may be achieved that the tube compensating element is correctly positioned already while the tube is inserted into the annulus of the plug connector and, moreover, that the tube compensating element can be prevented from falling out as far as possible while it is still unpressed.

According to an advancement, it is possible that the tube compensating element has a Shore D hardness of between 40 and 90, in particular between 50 and 80, preferably between 55 and 65. Especially a tube compensating element with such a Shore hardness is surprisingly well suited for having a sufficient formability, such that the plug connector can be pressed well and, moreover, has sufficient resistance to deformation such that a sufficiently strong, interlocking connection may be achieved. Moreover, by a tube compensating element with such a Shore D hardness in the pressed state, a tight connection between the individual components may be achieved.

Furthermore, it may be useful if the elastic modulus of the material of the tube is smaller than the elastic modulus of the material of the tube compensating element. This entails the advantage that the tube compensating element may form a durable clamping connection together with the tube.

Moreover, it may be provided that the tube compensating element is formed by a plastic part, in particular by an injection-molded plastic part. In particular a thus formed tube compensating element can be easily manufactured in a mass production process, wherein it can be manufactured with sufficient accuracy while retaining a high degree of design freedom.

It may also be provided that, as viewed in the axial direction, the tube and also the tube compensation element are locally deformed in the forming region of the first casing section or in the forming region of the second casing section, such that the tube and the tube compensation element are clamped between the first casing section and the second casing section. Particularly with a thus established clamping connection, a connection between the tube and the plug connector with a sufficiently high strength can be achieved.

Furthermore, it may be provided that by the forming region in the first casing section, a sealing effect between the first casing section and the tube may be achieved. This may be achieved in particular in that the first casing section is pressed to the tube.

According to the invention, a method for producing a plug assembly is provided. The method comprises the method steps:
providing a tube with a connection section;
providing a plug connector, which comprises a connector body, wherein the connector body comprises an annulus located between a sleeve-shaped first casing section annularly surrounding a central longitudinal axis of the plug connector in cross section and a sleeve-shaped second casing section of the plug connector annularly surrounding the central longitudinal axis, wherein the first casing section is surrounded by the second casing section and the first casing section of the connector body is connected to the second casing section on a first end section by a first front wall section and the casing sections are open to one another on a second end section, thereby forming a tube receiving side of the connector body,
inserting the connection section of the tube into the annulus of the connector body from the tube receiving side.

Prior to or simultaneously with the insertion of the connection section of the tube into the annulus of the connector body, a tube compensating element is inserted into the annulus of the connector body, such that
the tube compensating element is arranged between the tube and the second casing section, wherein in a subsequent method step the first casing section of the connector body is deformed in such a way that an interlocking connection is established between a forming region of the first casing section of the connector body and the tube, wherein the tube compensating element is clamped between the tube and the second casing section
or
that a tube compensating element is arranged between the tube and the first casing section, wherein in a subsequent method step the second casing section of the connector body is deformed in such a way that an interlocking connection is established between a forming region of the second casing section of the connector body and the tube, wherein the tube compensating element is clamped between the tube and the first casing section.

The method according to the invention entails the advantage that by the tube compensating element, tubes with different tube dimensions, in particular different outer diameters or different inner diameters and/or different wall thicknesses may be received in just one dimension size of the plug connector. Thus, it is not required to design a separate plug connector for each tube dimensioning. This entails the advantage that, on the one hand, the susceptibility to errors of the plug connectors can be surprisingly minimized and, on the other hand, costs can be saved. The susceptibility of the plug connectors to errors can be minimized by producing larger quantities in the individual series and thus putting more research work into the forming tool for the plug connector, which can then be of higher quality.

The Shore hardness is determined according to DIN ISO 7619-1. The values indicated in the present document are all determined in the Shore D method.

For the purpose of better understanding of the invention, it will be elucidated in more detail by means of the figures below.

These show in a respectively very simplified schematic representation:

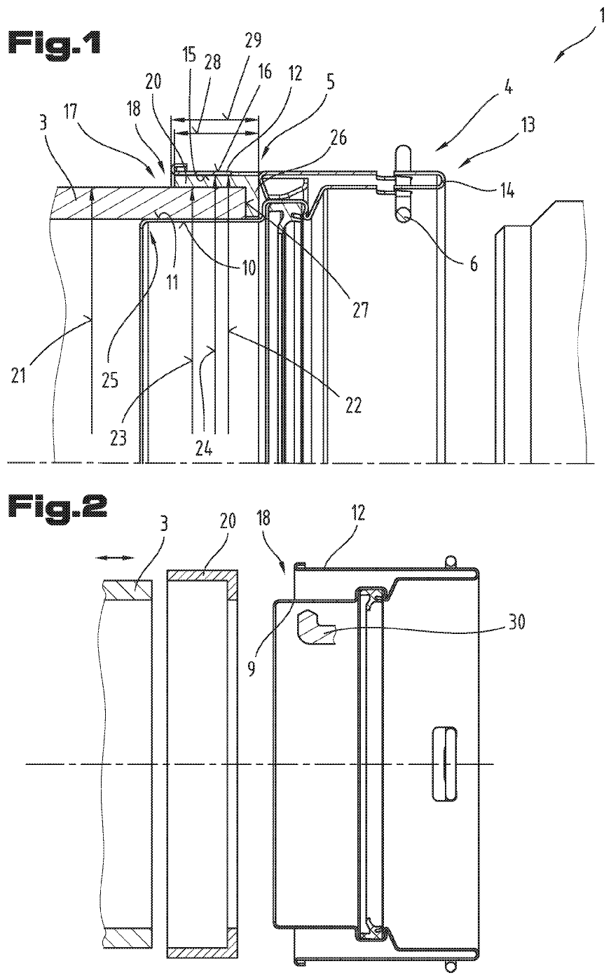

FIG. 1 a longitudinal section of a first exemplary embodiment of a plug assembly;

FIG. 2 an exploded view of the first exemplary embodiment of the plug assembly;

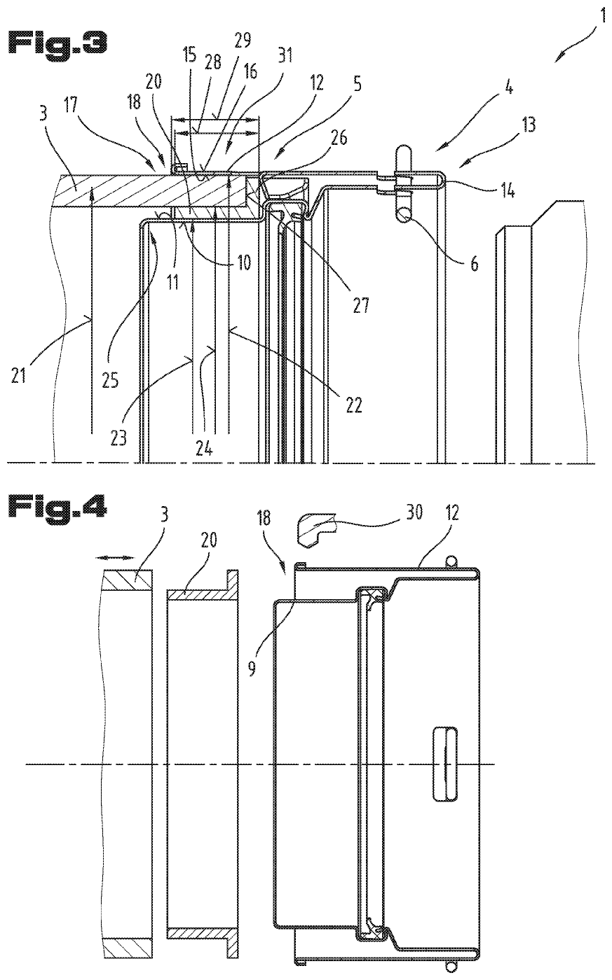

FIG. 3 a longitudinal section of a second exemplary embodiment of the plug assembly;

FIG. 4 an exploded view of the second exemplary embodiment of the plug assembly.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a view of a plug assembly 1, wherein it is represented in a quarter section. FIG. 1 further schematically represents a mating plug connector 2, which can be connected to the plug assembly 1. The interoperation between the plug assembly 1 and the mating plug connector 2 is sufficiently described in AT 509 196 B1.

In FIG. 1, the plug assembly 1 is shown in an assembled state. The plug assembly 1 comprises a tube 3 and a plug connector 4. The plug connector 4 comprises a connector body 5, which is preferably formed as a one-piece formed part, for example a deep drawing part, in particular of a hot dipped galvanized sheet metal. Preferably, all wall thicknesses of the casing sections of the connector body 5 may have approximately equally large.

The tube may be formed from a plastic material, in particular a thermoplastic material.

The plug assembly 1 is preferably used in a vehicle, in particular a road-bound power-driven vehicle with a combustion engine. The plug assembly 1 serves for connecting lines, tubes, or pipes for transporting liquid or gaseous media.

Furthermore, a locking element 6 installed in the plug connector 4 for securing the plug connector 4 and the mating plug connector 2 to each other can be seen.

It may particularly be provided that the mating plug connector 2 is formed to be rotationally symmetrical about a longitudinal axis 7 of the plug connector 4.

As can be seen from FIG. 1, a first casing section 9, which surrounds the central longitudinal axis 7 of the plug connector 4 in a sleeve-shape, is formed on the connector body 5. In other words, the first casing section 9 is a rotationally symmetrical hollow cylinder.

The first casing section 9 comprises an inner casing face 10 and an outer casing face 11. The first casing section 9 is surrounded by a second casing section 12, which is also formed to be rotationally symmetrical with respect to the central longitudinal axis 7. The first casing section 9 is connected to the second casing section 12 on a first end section 13 by means of a first front wall section 14. The first front wall section 14 may be designed in various different ways. Particularly, it may be provided that the first front wall section 14 is designed in the form of a fold, wherein the second casing section 12 is folded by about 180° with respect to the first casing section 9, whereby the second casing section 12 is arranged so as to surround the first casing section 9.

As the first casing section 9, the second casing section 12 also has an inner casing face 15 and an outer casing face 16.

The first casing section 9 has a stepped design in the exemplary embodiment shown.

Furthermore, a plug seal 8 may be received in the connector body 5.

Furthermore, it may be provided that an annulus 18 for accommodating the tube 3 is formed on a second end section 17 of the plug connector 4 between the first casing section 9 and the second casing section 12.

Furthermore, a tube compensating element 20 is formed, which is arranged between the tube 3 and the second casing section 12 in the present exemplary embodiment according to FIG. 1. As can well be seen from FIG. 1, the tube compensating element 20 serves for compensating a diameter difference between the outer diameter 21 of the tube 3 and an inner diameter 22 of the second casing section 12. An inner diameter 23 of the tube compensating element 20 is preferably approximately equally large as the outer diameter 21 of the tube 3.

An outer diameter 24 of the tube compensating element 20 is preferably approximately equally large as the inner diameter 22 of the second casing section 12. In the present exemplary embodiment, the inner diameter 23 of the tube compensating element 20 and/or the outer diameter 24 of the tube compensating element 20 are measured such that the tube compensating element 20 and the tube 3 can be easily inserted into the annulus 18. In this regard, in particular, it may be provided that the outer diameter 24 of the tube compensating element 20 and the inner diameter 22 of the second casing section 12 are designed as a clearance fit and/or that the inner diameter 23 of the tube compensating element 20 and the outer diameter 21 of the tube 3 are designed as a clearance fit.

As can further be seen from FIG. 1, a forming region 25, which in the finished installed state of the plug assembly 1 presses against the tube 3, whereby the tube 3 is deformed and pressed against the tube compensating element 20, is formed on the first casing section 9. In this regard, the tube compensating element 20 may also be slightly deformed and pressed against the second casing section 12. In other words, the tube 3 and the tube compensating element 20 may be clamped between the first casing section 9 and the second casing section 12. As can be further seen from FIG. 1, it can be provided that a stepped shoulder 26, on which an end face 27 of the tube 3 abuts, is formed on the tube compensating element 20. Furthermore, it may be provided that a longitudinal extension 28 of the tube compensating element 20 is approximately equally large as a longitudinal extension 29 of the annulus 18.

FIG. 2 describes the course of the method for assembling the plug connector 4 with the tube 3, wherein again, equal reference numbers and/or component designations are used for equal parts as before in FIG. 1. In order to avoid unnecessary repetitions, it is pointed to/reference is made to the detailed description in FIG. 1 preceding it.

As can be seen from FIG. 2, the tube 3 as well as the tube compensating element 20 are inserted into the annulus 18 from the tube receiving side 19 and are positioned there. In this regard, it may be provided that before the tube 3 is inserted into the annulus 18, the tube compensating element 20 is inserted into the annulus 18. Subsequently, the tube 3 can be inserted into the annulus 18 between the tube compensating element 20 and the first casing section 9.

Alternatively to this, it is also conceivable that the tube compensating element 20 is pushed onto the tube 3 and subsequently, the tube 3 along with the tube compensating element 20 are pushed into the annulus 18 together.

In a final method step, a pressing tool 30 acts against the inner casing face 10 of the first casing section 9, whereby it is locally deformed radially outwards in the forming region 25, whereby the first casing section 9 is pressed against the tube 3 and, by the deformation of the tube 3, it is pressed against the tube compensating element 20 and optionally, by the deformation of the tube compensating element 20, it is pressed against the second casing section 12.

FIG. 3 shows a further and possibly independent embodiment to the plug assembly 1, wherein again, equal reference numbers and/or component designations are used for equal parts as before in FIG. 1. In order to avoid unnecessary repetitions, it is pointed to/reference is made to the detailed description in FIG. 1 preceding it.

As can be seen from FIG. 3, it can be provided that the tube compensating element 20 is arranged between the tube 3 and the first casing section 9. In such an exemplary embodiment, a forming region 31 can be formed in the second casing section 12, by which the tube 3 is pressed against the tube compensating element 20 and thus the tube 3 is clamped on the tube compensating element 20.

FIG. 4 shows a further and possibly independent embodiment to the plug assembly 1, wherein again, equal reference numbers and/or component designations are used for equal parts as before in FIG. 1. In order to avoid unnecessary repetitions, it is pointed to/reference is made to the detailed description in FIG. 1 preceding it.

The course of the method for assembling the plug assembly 1, as is shown and/or described in FIG. 4, takes place similarly as the course of the method for assembling the plug assembly 1, as is shown and/or described in FIG. 2. The difference in the course of the method consists in that in the present exemplary embodiment, the tube compensating element 20 is placed between the tube 3 and the first casing section 9. Moreover, in such an exemplary embodiment, the pressing tool 30 is arranged on the outer side of the connector body 5, such that the forming region 31 can be established in the second casing section 12.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field. The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Plug assembly |
| 2 | Mating plug connector |
| 3 | Tube |
| 4 | Plug connector |
| 5 | Connector body |
| 6 | Locking element |
| 7 | Longitudinal axis of the plug connector |
| 8 | Plug seal |
| 9 | First casing section |
| 10 | Inner casing face |
| 11 | Outer casing face |
| 12 | Second casing section |
| 13 | First end section of plug connector |
| 14 | Front wall section |
| 15 | Inner casing face |
| 16 | Outer casing face |
| 17 | Second end section of plug connector |
| 18 | Annulus |
| 19 | Tube receiving side |
| 20 | Tube compensating element |
| 21 | Outer diameter of tube |
| 22 | Inner diameter of second casing section |
| 23 | Inner diameter of tube compensating element |
| 24 | Outer diameter of tube compensating element |
| 25 | Forming region of first casing section |
| 26 | Stepped shoulder |
| 27 | End face of tube |
| 28 | Longitudinal extension of tube compensating element |
| 29 | Longitudinal extension of annulus |
| 30 | Pressing tool |
| 31 | Forming region of second casing section |

1-10. (canceled)

11. A plug assembly (1), in particular for use in a vehicle, comprising a tube (3) and a plug connector (4), which comprises a connector body (5), wherein the connector body (5) comprises an annulus (18) located between a sleeve-shaped first casing section (9) annularly surrounding a central longitudinal axis (7) of the plug connector (4) in cross section and a sleeve-shaped second casing section (12) of the plug connector (4) annularly surrounding the central longitudinal axis (7), wherein the first casing section (9) is surrounded by the second casing section (12) and the first casing section (9) of the connector body (5) is connected to the second casing section (12) on a first end section (13) by a first front wall section (14) and the casing sections (9, 12) are open to one another on a second end section (17), thereby forming a tube receiving side (19) of the connector body (5), wherein the tube (3) is introduced into the annulus (18) of the connector body (5) from the tube receiving side (19),
wherein a tube compensating element (20) is arranged between the tube (3) and the second casing section (12), wherein the first casing section (9) of the connector body (5) is deformed such that an interlocking connection is established between a forming region (25) of the first casing section (9) of the connector body (5) and the tube (3), wherein the tube compensating element (20) is clamped between the tube (3) and the second casing section (12)
or
wherein a tube compensating element (20) is arranged between the tube (3) and the first casing section (9), wherein the second casing section (12) of the connector body (5) is deformed such that an interlocking connection is established between a forming region (31) of the second casing section (12) of the connector body (5) and the tube (3), wherein the tube compensating element (20) is clamped between the tube (3) and the first casing section (9),
wherein
the elastic modulus of the material of the tube (3) is smaller than the elastic modulus of the material of the tube compensating element (20).

12. The plug assembly according to claim 11, wherein the first casing section (9) of the connector body (5) abuts directly on the tube (3) in the forming region (25), wherein the tube (3) abuts directly on the tube compensating element (20) and wherein the tube compensating element (20) abuts directly on the second casing section (12).

13. The plug assembly according to claim 11, wherein the first casing section (9) of the connector body (5) abuts directly on the tube compensating element (20), wherein the tube compensating element (20) abuts directly on the tube (3) and wherein the tube (3) abuts directly on the forming region (31) of the second casing section (12).

14. The plug assembly according to claim 11, wherein the tube compensating element (20) has a longitudinal extension (28) and wherein the annulus (18) has a longitudinal extension (29), wherein the longitudinal extension (28) of the tube compensating element (20) amounts to between 80% and 120%, in particular between 90% and 110%, preferably between 95% and 105% of the longitudinal extension (29) of the annulus (18).

15. The plug assembly according to claim 11, wherein the tube compensating element (20) comprises a stepped shoulder (26), on which an end face (27) of the tube (3) abuts.

16. The plug assembly according to claim 11, wherein the tube compensating element (20) has a Shore D hardness of between 40 and 90, in particular between 50 and 80, preferably between 55 and 65.

17. The plug assembly according to claim 11, wherein the tube compensating element (20) is formed by a plastic part, in particular by an injection-molded plastic part.

18. The plug assembly according to claim 11, wherein, as viewed in the axial direction, the tube (3) and also the tube compensation element (20) are locally deformed in the forming region (25) of the first casing section (9) or in the forming region (31) of the second casing section (12), such that the tube (3) and the tube compensation element (20) are clamped between the first casing section (9) and the second casing section (12).

19. A method for producing a plug assembly (1), in particular a plug assembly (1) according to claim 11, comprising the method steps:
providing a tube (3);
providing a plug connector (4), which comprises a connector body (5), wherein the connector body (5) comprises an annulus (18) located between a sleeve-shaped first casing section (9) annularly surrounding a central longitudinal axis (7) of the plug connector (4) in cross section and a sleeve-shaped second casing section (12) of the plug connector (4) annularly surrounding the central longitudinal axis (7), wherein the first casing section (9) is surrounded by the second casing section (12) and the first casing section (9) of the connector body (5) is connected to the second casing section (12) on a first end section (13) by a first front wall section (14) and the casing sections (9, 12) are open to one another on a second end section (17), thereby forming a tube receiving side (19) of the connector body (5),
introducing tube (3) into the annulus (18) of the connector body (5) from the tube receiving side (19),
wherein
prior to or simultaneously with the insertion of the tube (3) into the annulus (18) of the connector body (5), a tube compensating element (20) is inserted into the annulus (18) of the connector body (5), such that
the tube compensating element (20) is arranged between the tube (3) and the second casing section (12), wherein in a subsequent method step the first casing section (9) of the connector body (5) is deformed in such a way that an interlocking connection is established between a forming region (25) of the first casing section (9) of the connector body (5) and the tube (3), wherein the tube compensating element (20) is clamped between the tube (3) and the second casing section (12)
or
a tube compensating element (20) is arranged between the tube (3) and the first casing section (9), wherein in a subsequent method step the second casing section (12) of the connector body (5) is deformed such that an interlocking connection is established between a forming region (31) of the second casing section (12) of the connector body (5) and the tube (3), wherein the tube compensating element (20) is clamped between the tube (3) and the first casing section (9)
wherein
the elastic modulus of the material of the tube (3) is smaller than the elastic modulus of the material of the tube compensating element (20).
